(19) United States
(12) Patent Application Publication
(10) Pub. No.: US 2016/0232135 A1
(43) Pub. Date: Aug. 11, 2016

(54) METHOD AND SYSTEM FOR DIGITAL BOOKMARK EFFECTING E-BOOK CONTENT REPAGINATION

(71) Applicant: Kobo Incorporated, Toronto (CA)

(72) Inventor: Inae HEO, North York (CA)

(73) Assignee: KOBO INCORPORATED, Toronto (CA)

(21) Appl. No.: 14/618,467

(22) Filed: Feb. 10, 2015

(51) Int. Cl. G06F 17/21; G06F 3/0483

(52) U.S. Cl. CPC G06F 17/217; G06F 3/0483; G06F 17/214

(57) ABSTRACT

A method and system for effecting repagination of e-book content in conjunction with applying a digital bookmark. The method comprises receiving a request for placement of a digital bookmark at a content portion within a current page of the e-book content rendered at the display screen, bookmarking the content portion, and repaginating the current page based on a location of the bookmarked content portion within the current page.

### TECHNICAL FIELD

Examples described herein relate to a system and method for operating a computing device in effecting repagination of content within an e-book.

### BACKGROUND

An electronic personal display is a mobile computing device that displays information to a user, While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below, The drawings referred to in this brief description of the drawings should not be understood as being drawn to scale unless specifically noted.

FIG. 1 illustrates a system utilizing applications and providing e-book services on a computing device configured for operation in effecting a repagination of an e-book, in an embodiment.

FIG. 2 illustrates a schematic architecture of a computing device configured for operation in effecting a repagination of an e-book, according to an embodiment.

FIGS. 3a-3c illustrate example embodiments for operation in effecting a repagination of e-book.

FIG. 4 illustrates a method for operation in effecting a repagination of an e-book, according to an embodiment.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via. discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

While conventional physical paper books typically include a fixedly-configured table of contents page(s) intended to assist a user or observer to locate a desired portion or page of the book for reading, a digitally rendered e-book may be configured in other, more fluid arrangements that allow alternative ways for a user to conveniently access a particular content portion or page of the e-book.

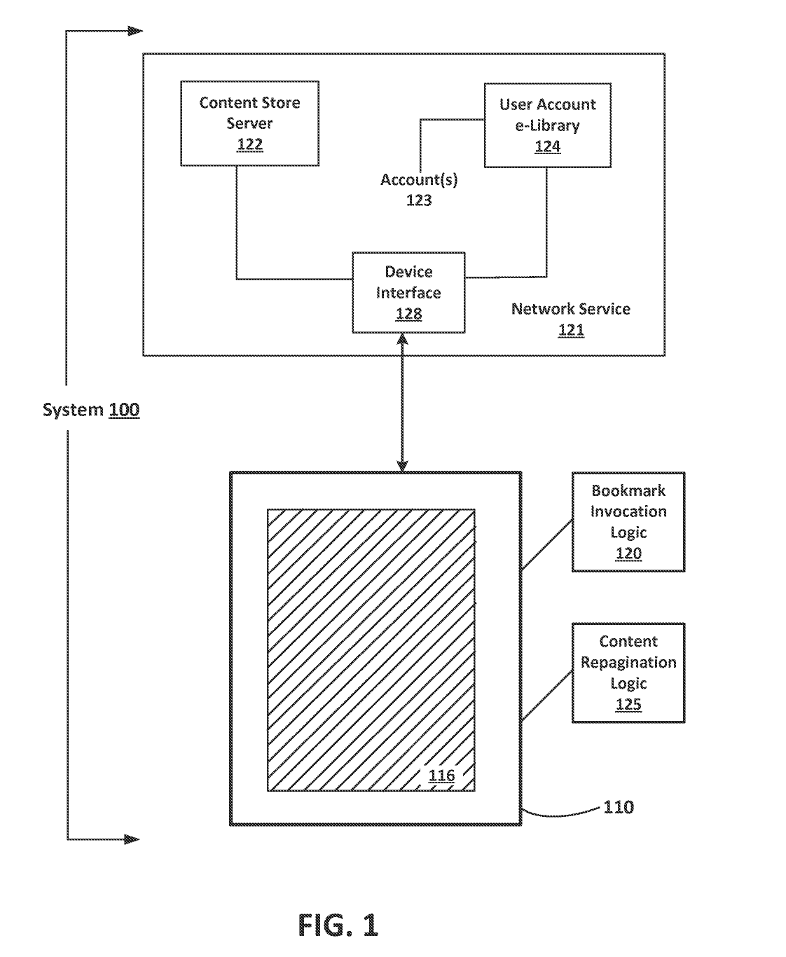

FIG. 1 illustrates a system 100 for utilizing applications and providing e-book services on a computing device configured for operation of a time-release-based e-book gifting scheme, according to an embodiment. In an example of FIG. 1, system 100 includes an electronic personal display device, shown by way of example as e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 121 and enables e-books provided through the service to be viewed and consumed by way of e-reading. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the c-reading device 110 can also have an E-ink display.

In additional detail, the network service 121 can include a device interface 128, a content store server 122, and a user account electronic library (e-library) 124 storing e-books or digital content items. In some embodiments, content store server 122 and user account e-library may be implemented via server computing devices, as well as a server cloud computing system. Content store server 122 may be an online store for purchasing of digital content items for download therefrom onto a resident memory of a e-reading device 110 and/or user account e-library 124. User account e-library 124 associates the e-reading device 110 with a user having a account 123. The account 123 can also be associated with ownership of, and/or accessibility to, one or more digital content items stored in content store server 122. In one embodiment, the digital content items are e-books, and the content store server 122 is an online store having e-books for purchase or other licensed use. The device interface 128 can handle requests from the e-reading device 110 with regard to services and functionality of the network service 121. The device interface 128 can utilize information provided with user account 123 in order to enable services, such as purchasing and downloading of e-books into user account e-library 124, and determining what e-books and content items providable via content store server 122 are associated with, and accessible to, user account 123. Additionally, the device interface 128 can provide the e-reading device 110 with access to the on-line content store server 122. The device interface 128 can handle input to identify content items (e.g., e-books), and further to associate content items to account 123 of the user e-library 124.

Yet further, content store server 122 and user account e-library 124 can retain metadata for individual accounts 123 to identify e-books or other digital content items that have been purchased or made available for consumption for a given account Thus, information relating to e-books within user account e-library 124 can include a metadata set in addition to substantive digital text and image content portions. The metadata set can include, for example, information such as the graphic representation of the e-book, such as including artwork- or image-based representation of a counterpart physical paper book cover, as well as summary information, author information, title, short synapse or book review, publication date and language of the e-book, and book or volume series information.

The e-reading device 110, interchangeably referred to as display device 110 herein, may be associated with the user account 123, and in fact multiple such display devices may be associated with a same account. As described in greater detail below, e-reading device 110 can locally store content items (e.g., e-books) that are purchased or otherwise made available to the user of the e-reading device 110 as well as to archive, in user account 124, e-books and other digital content items that have been purchased for the user account 123, but are not necessarily stored in local resident memory at display device 110.

With reference to an example of FIG. 1, e-reading device 110 can include a touchscreen display 116. In an embodiment, the display screen 116 is touch-sensitive, to process touch inputs including gestures (e.g., swipes). For example, the display screen 116 may be integrated with one or more touch sensors to provide a touch-sensing region on a surface of the display screen 116. For some embodiments, the one or more touch sensors may include capacitive sensors that can sense or detect a human body's capacitance as input. In the example of FIG. 1, the touch-sensing region coincides with a substantial surface area, if not all, of the display screen 116.

In some embodiments, the e-reading device 110 includes features for providing functionality related to displaying paginated content, including paginated content comprising an e-magazine or e-comic book. The e-reading device 110 can include page transitioning logic, which enables the user to transition through paginated content. The e-reading device 110 can display pages of e-books, e-magazines and e-comics, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic can operate to enable the user to transition from a given page state to another page state in the specific example embodiment where a given page state coincides with a single page, for instance, each page state corresponding to one page of the digitally constructed, ordered sequence of pages paginated to comprise, in one embodiment, an e-book. In some implementations, the page transitioning logic enables single page transitions, chapter transitions, or cluster transitions (multiple pages at one time).

According to some embodiments, the e-reading device 110 includes display sensor logic to detect and interpret user input or user input commands made through interaction with the touch sensors. By way of example, display sensor logic can detect a user making contact with the touch-sensing region of the display screen 116, otherwise known as a touch event. More specifically, display sensor logic can detect a touch events also referred to herein as a tap, an initial tap held in contact with display screen 116 for longer than some pre-defined threshold duration of time (otherwise known as a “long press” or a “long touch”), multiple taps performed either sequentially or generally simultaneously, swiping gesture actions made through user interaction with the touch sensing region of the display screen 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic can interpret such interactions in a variety of ways. For example, each such interaction may be interpreted as a particular type of user input associated with a respective input command, execution of which may trigger a change in state of display 116.

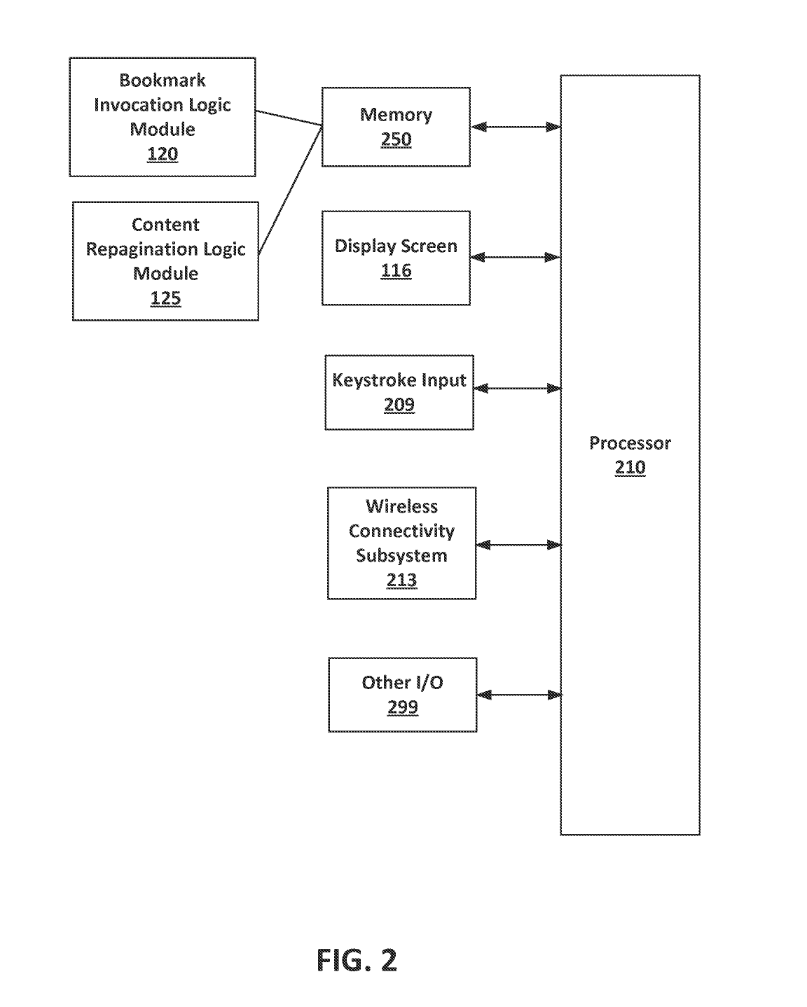

Bookmark invocation logic module 120 provides functionality, via display screen 116 of display device 110, for selecting a content portion, such as a sentence, word or phrase, within a digitally rendered page of e-book content, with an intention of placing or invoking a digital bookmark for association therewith. Content repagination logic 125 provides functionality for repaginating the digital pages of the e-book for presentation of content in a different manner within the displayed pages of e-book, as will be described further in regard to FIGS. 2-4.

Bookmark invocation logic module 120 and content repagination logic 125 can be implemented as software modules comprising instructions stored in a memory of a computing device, such as content store server 122 and/or display device 110. In one or more embodiments of bookmark invocation logic module 120, and content repagination logic module 125 described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of bookmark invocation logic module 120 and content repagination logic module 125 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

FIG. 2 illustrates a schematic architecture of a computing device configured for operation of an excerpting interface for apportioned content of an e-book, according to an embodiment.

E-reading device 110 further includes processor 210, a memory 250 storing instructions and logic pertaining at least to content repagination logic 125 and bookmark invocation logic module 120.

Processor 210 can implement functionality using the logic and instructions stored in memory 250. Additionally, in some implementations, processor 210 communicates with the network service 121 (see FIG. 1). More specifically, the e-reading device 110 can access the network service 121 to receive various kinds of resources (e.g., digital content items such as e-books, configuration files, account information), as well as to provide information (e.g., user account information, service requests etc.). For example, e-reading device 110 can receive application resources, such as e-books or media files, that the user elects to purchase or otherwise download via the network service 121. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components may be integrated with display 116, In other embodiments, the touch sensor components may be provided (e.g., as a layer) above or below display 116 such that individual touch sensor components track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components at display 116, keystroke input 209 such as from a virtual or rendered keyboard, and other input mechanisms 299 (e.g., buttons, mouse, microphone, etc.). With reference to examples described herein, processor 210 can respond to input detected at the touch sensor components. In some embodiments, processor 210 responds to inputs from the touch sensor components in order to facilitate or enhance e-book activities such as generating e-book content on display 116, performing page transitions of the displayed e-book content, powering off the device 110 and/or display 116, activating a screen saver, launching or closing an application, and/or otherwise altering a state of display 116.

In some embodiments, memory 250 may store display sensor logic that monitors for user interactions detected through the touch sensor components, and further processes the user interactions as a particular input or type of input. In an alternative embodiment, display sensor logic module may be integrated with the touch sensor components. For example, the touch sensor components can be provided as a modular component that includes integrated circuits or other hardware logic, and such resources can provide some or all of display sensor logic. In variations, some or all of display sensor logic may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which display device 110 is intended to operate, such as in accordance with Wi-Fi, Bluetooth, Near Field Communication (NFC) communication protocols, and the like.

Bookmark invocation logic module 120 can be implemented as a software module, comprising instructions stored in memory 250, on mobile display device 110. In one implementation, the local memory 250 can include records for each e-book in the user's e-library account 124, each record include metadata of the e-books therein. The user may have the content portion of select e-books archived remotely at a computer server cloud system, so as not to reside in the local memory 250, but be provided by the network service 121 upon request or as needed.

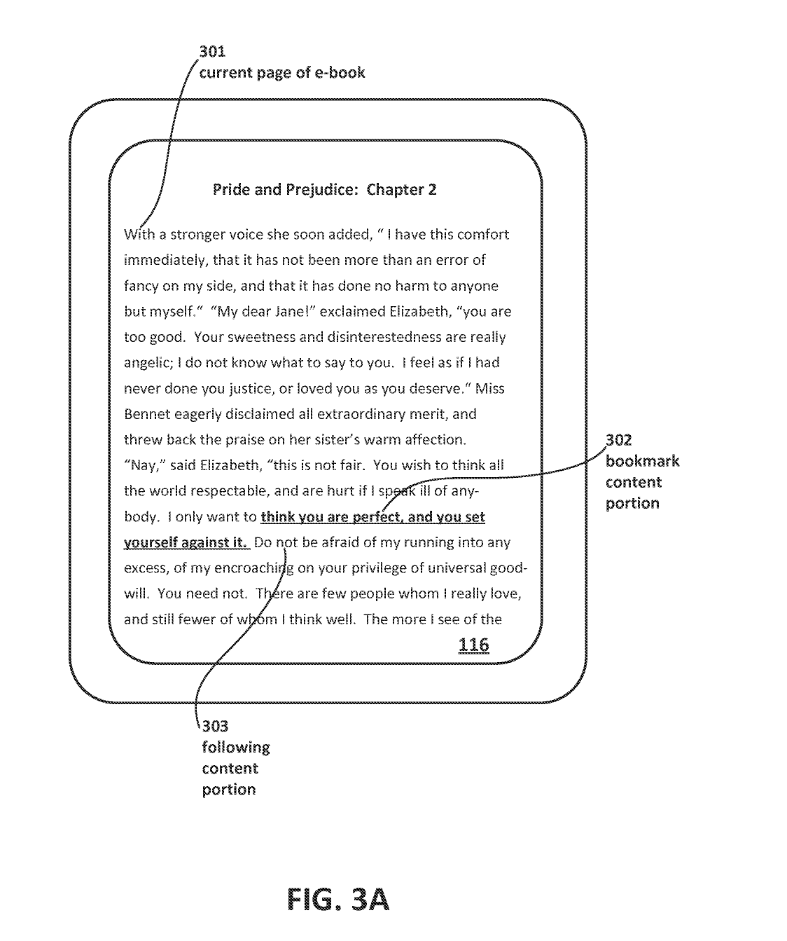

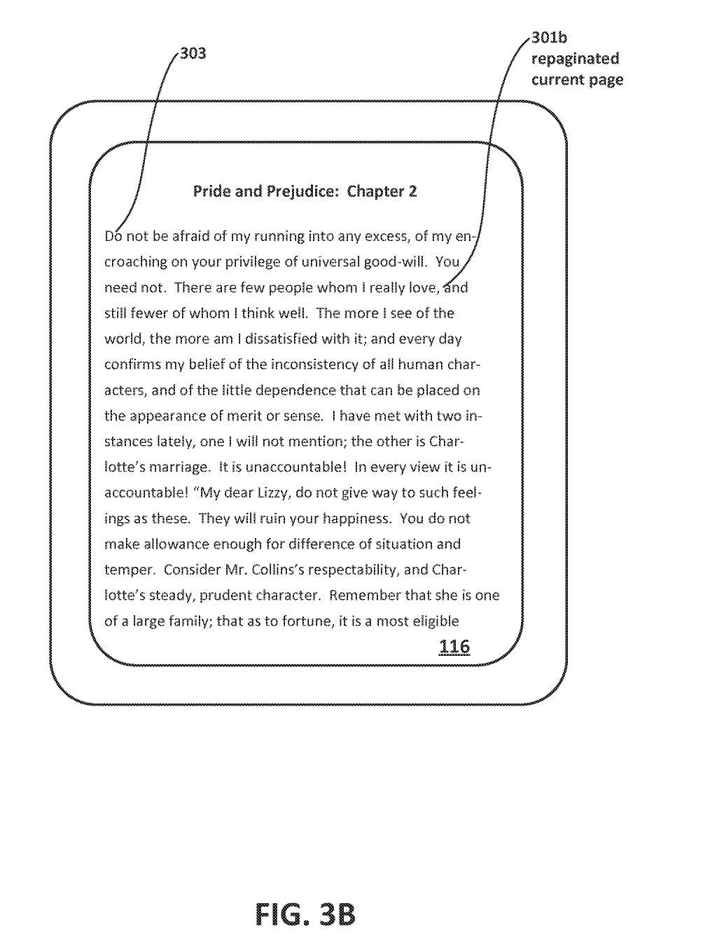

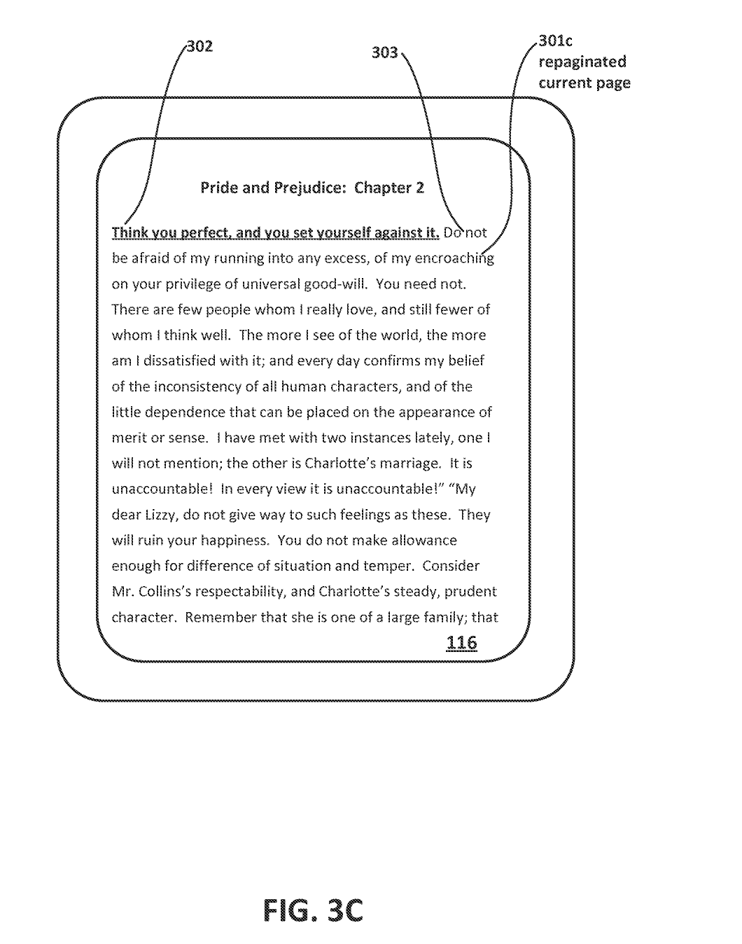

FIGS. 3a-3c depict various example embodiments operation in effecting a repagination of un e-book content of an e-book in conjunction with a digital bookmark placement. Bookmark invocation logic module 120 in conjunction with content repagination logic 125 function, at least in part, to provide an interface, via display screen 116 of display device 110, for selecting content portions of an e-book content page 301 under display at display screen 116, and effecting a repagination of the original sequence of digital pages of the e-book for presentation, as will be described further in regard to FIGS. 2-4.

FIG. 3a illustrates a view of a digitally constructed current page 301 of e-book content rendered within display screen 116 of e-reading display device 110. A may user decide to discontinue e-reading and place a digital bookmark at their most recently read position within current page 301 that will later enable them to seamless continue reading without having to mentally keep track of their of their last-read line, for instance. Various selection means may be used to identify their last read content portion 302 for bookmarking within the current page 301, such as by highlighting the desired content portion 302 at which e-reading is being discontinued then invoking a menu or sub-menu of bookmarking command options, The highlight action may be from an observer's finger, thumb or a stylus device, superposed upon a touchscreen embodiment of display 116, sensed via touch sensors thereon. White bookmark content portion 302 is depicted in FIG. la as a sentence portion, it is contemplated that other variations may be applied, including a last-read word or term, a particular last-read line, or even a last-read complete sentence. Also depicted is following content portion 303 that immediately follows bookmark content portion 302 within current page 301, Bookmark invocation logic 120 keeps track of digital bookmark content portion 302 as placed by a user, and also following content portion 303 within e-book content page 301.

FIG. 3b illustrates a view within display screen 116 where the pages of the e-book content have been repaginated to generate a re-constructed current page 301b showing following content 303 at the beginning of repaginated current page 301b. Content repagination logic module 125 monitors for receipt of any bookmarking placement actions at e-book content pages rendered on display screen 116 of e-reading device 110, and initiates repagination of e-book pages for display accordingly as described. As part of the content repagination, text from and subsequent to following content portion 303 of current page 301 current page is reflowed onto repaginated current page 301b. In this manner the lines of text content are repaginated to reflow, or line-wrap, over into respective next pages in the ordered sequence of digital pages comprising the e-book content, while maintaining text attributes such as font size, text spacing, word spacing, etc. for continuity in reading by the observer.

FIG. 3c illustrates, in an alternate embodiment, repaginated current page 301c wherein the bookmark content portion 302 may be provided for the viewer's convenience and continuity of the reading experience at the very beginning of the repaginated current page 301c, just before following content portion 303. Bookmarked content portion 302 may be rendered visually different from remainder content of repaginated current page 301c, such as by color, shading, illumination or brightness, text font size of included text, or any combination thereof.

In this manner, bookmark invocation logic 120 operates in conjunction with content repagination logic module 125 to repaginate digitally constructed e-book pages subsequent to a digital bookmark placement at a content portion of a displayed page of e-book content, whereupon the above described repagination of current page text content conceivably ripples throughout a series of following or subsequent digitally constructed pages of the e-book being viewed or read serially in progression.

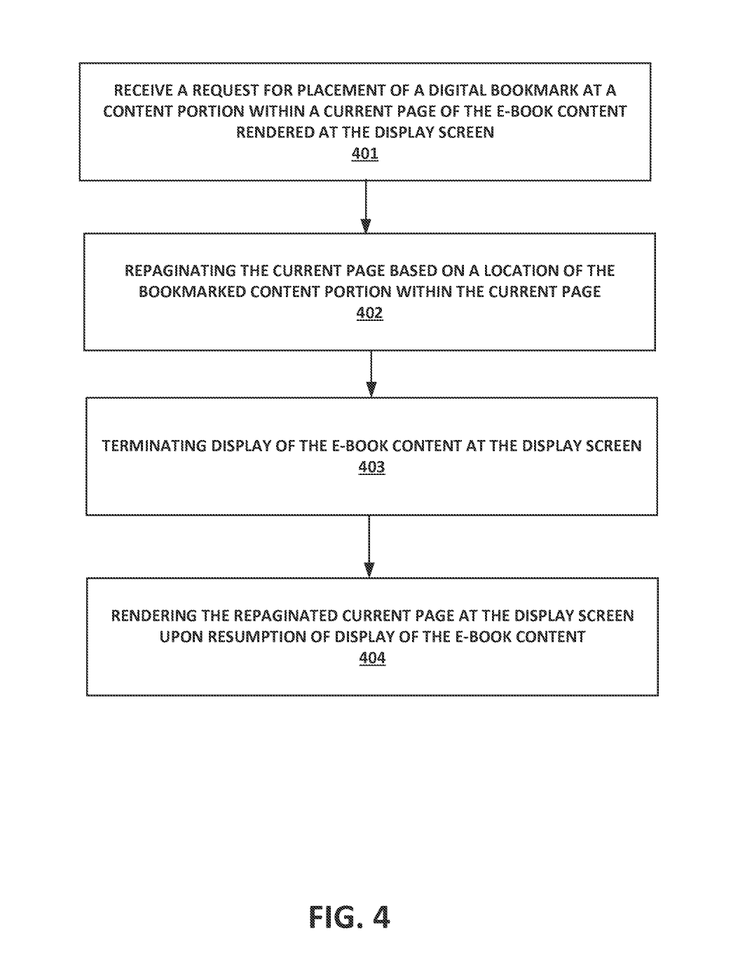

Next with reference to FIG. 4, illustrated is a method for operation in configuring and launching an e-book reading interface on a computer device having a touchscreen display, according to an embodiment. In describing the example of FIG. 4, reference will be made to components such as described with regard to FIGS. 1 through 3a-3c for purposes of illustrating components for performing a step or sub-step as described.

At 401, one embodiment receives a request for placement of a digital bookmark at a content portion 302 within a current page 301 of the e-book content rendered at the display screen 116. In addition, the bookmarking of the content portion is performed.

At 402, one embodiment repaginates the current page 301b, 301c based on a location of the bookmarked content portion 302 within the current page 301.

At 403, one embodiment terminates display of the e-book content at the display screen 116.

At 404, one embodiment renders the repaginated current page 301b, 301c at the display screen 116 upon resumption of display of the e-book content.

Although illustrative embodiments have been described in detail herein with reference to the accompanying drawings, variations to specific embodiments and details are contemplated and encompassed by this disclosure. For instance, with regard to FIG. 4 as described above, it is contemplated that step 403 may alternatively be performed before step 402, in a variation embodiment. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a display screen, a memory storing instructions and an e-book having content displayable according to an ordered sequence of digitally constructed pages, the method comprising:
receiving a request for placement of a digital bookmark at a content portion within a current page of the e-book content rendered at the display screen;
bookmarking the content portion; and
repaginating the current page based on a location of the bookmarked content portion within the current page.

2. The method of claim 1 further comprising terminating display of the e-book content at the display screen.

3. The method of claim 2 further comprising rendering the repaginated current page at the display screen upon resumption of display of the e-book content.

4. The method of claim 3 wherein the resumption of display of the e-book content is triggered upon a power-on of the computing device.

5. The method of claim 1 wherein a beginning content portion of the repaginated current page includes a text content portion immediately following the bookmarked content portion.

6. The method of claim 1 wherein a beginning content portion of the repaginated current page includes the bookmarked content portion.

7. The method of claim 6 wherein the bookmarked content portion is rendered visually distinct from a remainder of the repaginated current page.

8. The method of claim 7 wherein the visual distinction consists of one of: an underlining, a color highlighting, a text color, a text brightness level, a font type and a boldness type.

9. The method of claim 1 wherein the e-book is one of an e-magazine and an e-comic.

10. A computer-readable medium that stores instructions and an e-book for a computing device, the computing device including a processor and a memory storing instructions, the instructions being executable by the processor to cause the computing device to perform operations that include:
receiving a request for placement of a digital bookmark at a content portion within a current page of the e-book content rendered at a display screen, the e-book content being displayable at the display screen according to an ordered sequence of digitally constructed pages;
bookmarking the content portion; and
repaginating the current page based on a location of the bookmarked content portion.

11. A computing device comprising:
a display screen;
a memory that stores a set of instructions and an e-book, the e-book having content displayable at the display screen according to an ordered sequence of digitally constructed pages; and
a processor that access the instructions in memory, the processor further configured to:
receive a request for placement of a digital bookmark at a content portion within a current page of the e-book content rendered at the display screen;
bookmark the content portion; and
repaginate the current page based on a location of the bookmarked content portion.

12. The computing device of claim 11 wherein the processor is further configured to terminate display of the e-book content at the display screen.

13. The computing device of claim 12 wherein the processor is further configured to render the repaginated current page at the display screen upon resumption of display of the e-book content.

14. The computing device of claim 13 wherein the processor is further configured to resume display of the e-book content upon a power-on of the computing device.

15. The computing device of claim 11 wherein a beginning content portion of the repaginated current page includes a text content portion immediately following the bookmarked content portion.

16. The computing device of claim 11 wherein a beginning content portion of the repaginated current page includes the bookmarked content portion.

17. The computing device of claim 16 wherein the bookmarked content portion is rendered visually distinct from a remainder of the repaginated current page.

18. The computing device of claim 17 wherein the visual distinction consists of one of: an underlining, a color highlighting, a text color, a text brightness level, a font type and a boldness type.

19. The computing device of claim 11 wherein the e-book is one of an e-magazine and an e-comic.
